(19) United States
(12) Patent Application Publication
(10) Pub. No.: US 2008/0098734 A1
(43) Pub. Date: May 1, 2008

(54) Engine Control Method

(76) Inventor: Jan-Ola Olsson, Gothenburg (SE)

Correspondence Address: ALLEMAN HALL MCCOY RUSSELL & TUTTLE, LLP, 806 S.W. BROADWAY, SUITE 600, PORTLAND, OR, 97205, US

(21) Appl. No.: 11/553,940

(22) Filed: Oct. 27, 2006

(51) Int. Cl. F02D 23/00; F02B 33/44

(52) U.S. Cl. 60/605.1; 60/600; 60/601

(57) ABSTRACT

A method and apparatus is shown for operating an internal combustion engine having a turbocharger, comprising comparing estimated air flow to a mass air flow sensor signal to create a flow deviation signal, using the flow deviation signal and a modeled volumetric efficiency to calculate a required intake pressure, and using the required intake pressure as a set point for boost pressure control.

### FIELD

The present application relates to controlling intake pressure in a turbo engine.

### BACKGROUND AND SUMMARY

Engine Management System (EMS) may control internal combustion engines by reading sensors in the engine and using the information to control engine operation. An EMS can improve fuel efficiency, increase power, and decrease pollution by compensating for many variables such as ambient temperature, humidity, altitude (air density), fuel octane rating, driver demands, etc. In a torque based EMS, air flow control may be used to accurately provide a specified torque.

Air flow characteristics and performance are different for naturally aspirated and forced induction engines for various conditions. A naturally aspirated engine can use a Mass Air Flow (MAF) sensor to create a feedback signal to a throttle controller and accurately control air flow and therefore accurately control engine operation. Air flow may be controlled as disclosed in U.S. Pat. No. 6,636,796, issued to Kolmanovsky, et al. In Kolmanovsky, the air flow into an engine is estimated via a speed-density calculation wherein volumetric efficiency is estimated on-line in a three observer system.

For a turbo charged engine, a throttle controller can be used to control airflow if an added charge air cooler volume between the MAF sensor and the throttle is taken into account. However, the boost pressure required to reach a target air flow may not be accurately calculated directly from the MAF sensor without adding an extra feedback loop.

In turbo charged applications, a model of volumetric efficiency may be used to calculate the required intake pressure from a required air flow. This model may be accurate at well controlled and steady state operating conditions. However, normal operating conditions are far from steady state, and environmental conditions may vary considerably. Also, the temperature history of an engine can result in heat transfer between piping and air that differs significantly from the steady state conditions. As a result, there may be errors in torque control in a turbo engine under certain conditions such as at high altitude where a model of volumetric efficiency is less accurate, or after a long period of idle when piping in the engine compartment is warmed up.

In one approach, the above issues may be addressed by using a model of volumetric efficiency and adding a correction. The model can be used both to estimate required intake pressure for a required air flow and to estimate the air flow from the actual intake pressure. By comparing an estimated air flow to a MAF sensor signal, a flow deviation signal can be generated. The flow deviation signal can be used with the modeled volumetric efficiency to calculate a pressure correction. By using the corrected required intake pressure as a set point for the boost pressure control, the MAF sensor signal can equal the required mass air flow when the boost control error is zero. In this way, an EMS can control an engine to deliver a specified torque even in situations where modeled volumetric efficiency is less accurate due to high altitudes, transient states, heated piping, etc.

In another approach, the above issues may be addressed by a method of operating an internal combustion engine having a turbocharger, comprising comparing estimated air flow to a mass air flow sensor signal to create a flow deviation signal, using the flow deviation signal and a modeled volumetric efficiency to calculate a required intake pressure, and using the required intake pressure as a set point for boost pressure control.

### DETAILED DESCRIPTION OF THE DRAWINGS

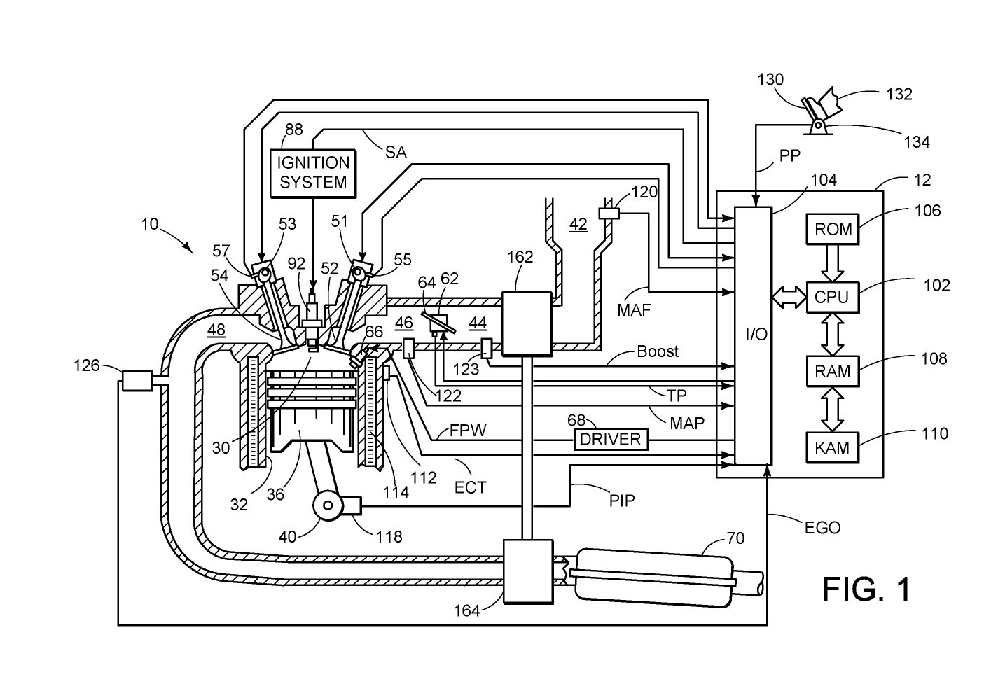

FIG. 1 is a schematic view of an internal combustion engine and control system.

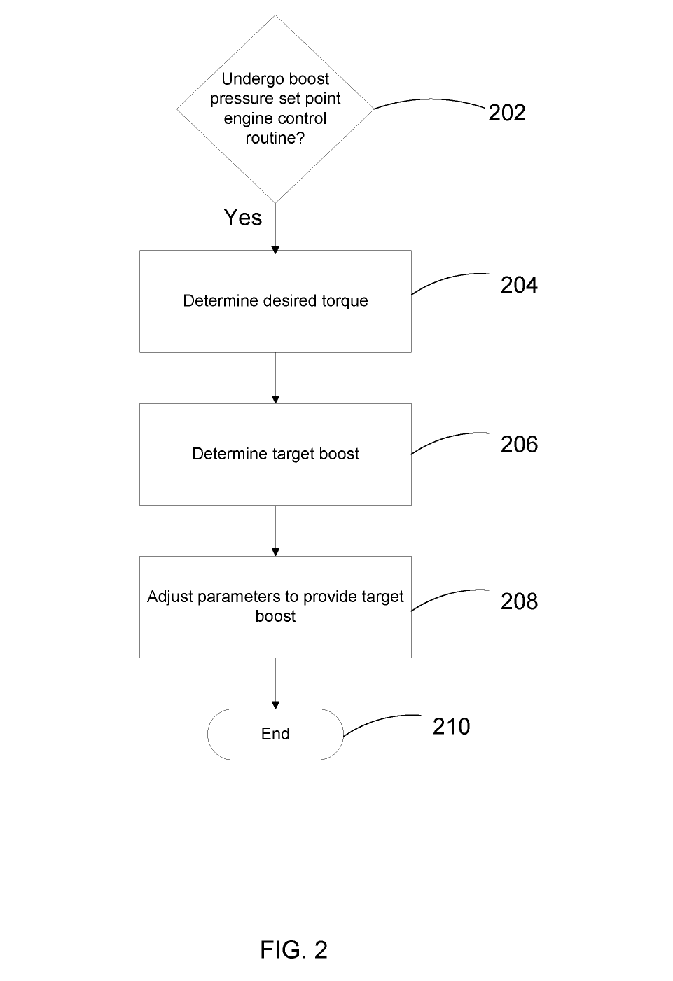

FIG. 2 is a flow chart for an example engine control routine.

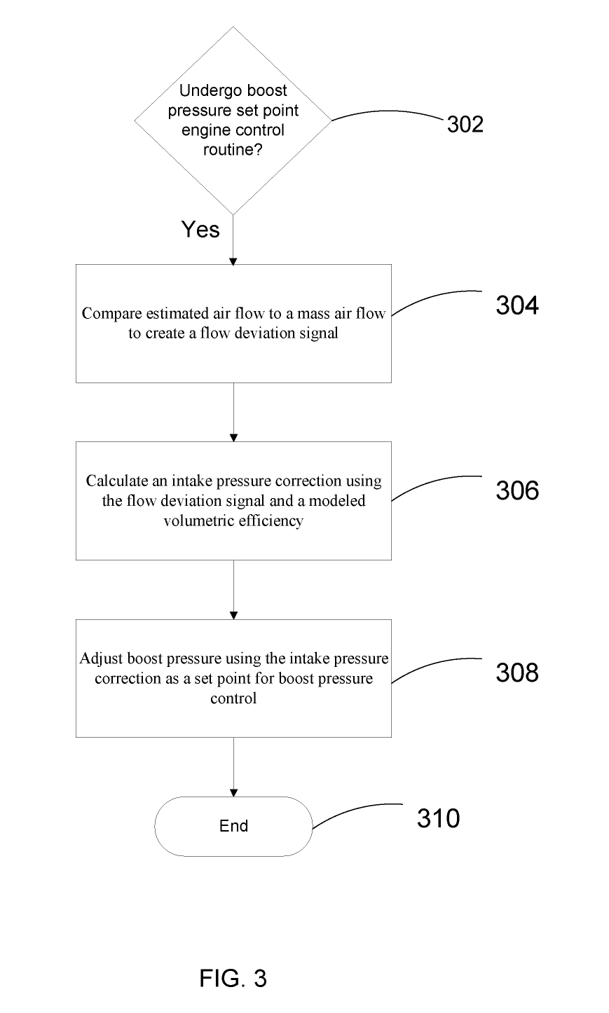

FIG. 3 is a flow chart for an example engine control routine.

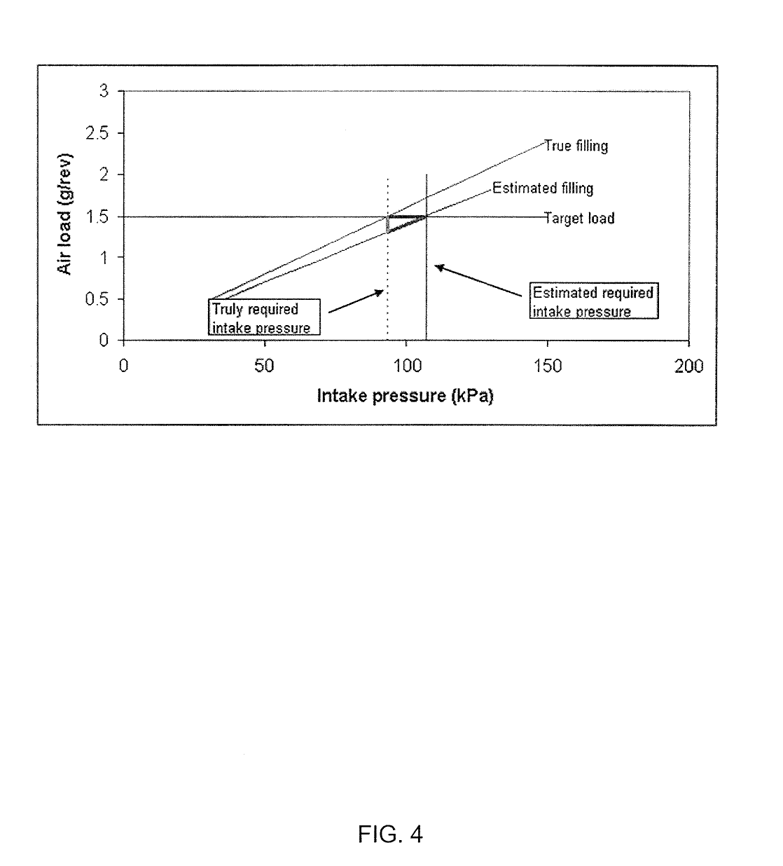

FIG. 4 is a graph comparing correlations between intake pressure and air load.

### DETAILED DESCRIPTION

FIG. 1 is a schematic view of an internal combustion engine 10 and control system 12. Combustion chamber 30 of engine 10 includes combustion chamber walls 32 with piston 36 positioned therein and connected to crankshaft 40. In one example, piston 36 includes a recess or bowl (not shown) to form selected levels of stratification or homogenization of charges of air and fuel. Alternatively, a flat piston may also be used.

Combustion chamber 30 is shown communicating with intake manifold 46 and exhaust manifold 48 via respective intake valves 52a and 52b (not shown), and exhaust valves 54a and 54b (not shown). Fuel injector 66 is shown directly coupled to combustion chamber 30 for delivering liquid fuel directly therein in proportion to the pulse width of signal FPW received from controller 12 via conventional electronic driver 68. Fuel is delivered to fuel system (not shown) including a fuel tank, fuel pumps, and a fuel rail. In some embodiments, engine 10 may include a plurality of combustion chambers each having a plurality of intake and/or exhaust valves. FIG. 1 is just one example of an internal combustion engine and embodiments are not limited to the engine in FIG. 1. For example, embodiments may use fuel delivery systems other than direct injection.

Intake manifold 46 is shown communicating with a throttle body via throttle plate 64. In this particular example, throttle plate 64 is coupled to electric motor 62 so that the position of throttle plate 64 is controlled by controller 12 via electric motor 62. Exhaust gas oxygen sensor 126 is shown coupled to exhaust manifold 48 upstream of catalytic converter 70. In an alternative embodiment, sensor 126 can provide a signal which indicates whether exhaust air-fuel ratio is either lean of stoichiometry or rich of stoichiometry. The present embodiment contains a mechanical turbocharger 162 to generate a boost pressure 44, however a mechanical supercharger (not shown) may be used to boost the intake pressure 46 in engine 10. In some embodiments, exhaust gas oxygen sensor 126 resides between turbocharger 164 and catalytic converter 70.

Controller 12 activates fuel injector 66 so that a desired air-fuel ratio mixture is formed. Controller 12 controls the amount of fuel delivered by fuel injector 66 so that the air-fuel ratio mixture in chamber 30 can be selected to be substantially at (or near) stoichiometry, a value rich of stoichiometry, or a value lean of stoichiometry. Further, controller 12 is configured to activate fuel injector 66 so that multiple fuel injections may be performed during a cycle.

A Nitrogen oxide (NOx) absorbent or trap may be positioned downstream of catalytic converter 70. A NOx trap absorbs NOx when engine 10 is operating lean of stoichiometry. The absorbed NOx is subsequently reacted with HC and catalyzed during a NOx purge cycle when controller 12 causes engine 10 to operate in either a rich mode or a near stoichiometric mode.

Controller 12 is shown in FIG. 1 as a conventional microcomputer including: microprocessor unit 102, input/output ports 104, an electronic storage medium of executing programs and calibration values, shown as read-only memory chip 106 in this particular example, random access memory 108, keep alive memory 110, and a conventional data bus.

Controller 12 is shown receiving various signals from sensors coupled to engine 10, in addition to those signals previously discussed, including: measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 coupled to crankshaft 40 giving an indication of engine speed (RPM); throttle position TP to detect the position of throttle plate 64; absolute Manifold Pressure Signal MAP from sensor 122; and a boost pressure signal (Boost) from boost pressure sensor 123 to measure boost pressure 44 between the turbo compressor 162 and the throttle plate 64. Engine 10 may have a charge air cooler between turbo compressor 162 and throttle plate 64. Other embodiments may have a throttle plate in another part of the throttle body. Engine speed signal RPM is generated by controller 12 from signal PIP in a conventional manner and manifold pressure signal MAP provides an indication of engine load.

In order to meet a target torque in a fuel efficient manner, an engine controller 12 for a turbo charged combustion engine 10 controls both the throttle plate 64 and turbocharger 162. The controller 12 can use a torque model to convert a requested torque to a target air load, i.e., mass of air per crank shaft revolution. In some embodiments, MAF sensor 120 can provide an accurate feedback signal to controller 12 for the control of air load using the throttle plate 64. However, it is convenient to control turbocharger 162 in terms of pressure instead of air load, i.e., a target boost pressure. Therefore, controller 12 may convert a target air load to a required intake pressure using a volumetric efficiency model of engine 10. In this manner, required intake pressure can be used to calculate a target boost pressure by adding a pressure drop over the throttle 64. However, when the pressure drop across the throttle plate 64 is low, an error in modeled volumetric efficiency can result in a target boost pressure that is too low to meet the target load.

As will be described in more detail below, embodiments may use a model of volumetric efficiency with an added correction to estimate a required intake pressure for a required air flow, or to estimate an air flow from an actual intake pressure 46. In one embodiment, estimated air flow may be compared to a MAF sensor 120 signal to calculate a flow deviation. Engine controller 12 then can calculate an intake pressure correction using the flow deviation together with a modeled volumetric efficiency of engine 10. By using the required intake pressure correction as a set point for boost pressure control, a MAF sensor 120 reading should equal the required mass air flow when boost control error is zero.

In some embodiments, by estimating intake pressure at a target load, an estimated volumetric efficiency can be calculated by dividing the target load by the estimated intake pressure. A state observer can be used in a state space model to provide feedback to control a system where there is no direct access to the state of the system. That is, state observers can be designed to estimate the signals that cannot be measured so long as the system is observable. A state observer can then be used to estimate the position to provide full state access for feedback control. Estimated volumetric efficiency can then be used as a state observer in a control system, as explained below.

In some embodiments, estimated intake pressure can be corrected to correspond to a target load. Estimated volumetric efficiency, V, can be calculated in controller 12 for the target operating point, so that it describes the relation between the target load and an estimated required intake pressure according to equation A. Volumetric efficiency is represented by v.

\hat{v}=(target load)/estimated required intake pressure (A)

Then, at steady state and high load, air flow can be modeled as estimated intake pressure multiplied by estimated volumetric efficiency, then multiplied by engine rotation speed (Ne) and divided by 60. Modeled air flow is:

Mth_{model}=estimated intake pressure·\hat{v}·Ne/60 (B)

At the same time, the MAF signal from MAF sensor 120 can be defined as:

MAF=intake pressure·\hat{v}Ne/60 (C)

At high load, close to wide open throttle, and with diminishing control errors, the three pressures estimated required intake pressure, estimated intake pressure, and true intake pressure, all converge towards the same value. The difference between MAF and the modeled air flow is therefore:

\dot{m}ₑᵣᵣ=MAF−Mth_{model}=estimated intake pressure·Ne/60(v−\hat{v}) (D)

By solving equation D for volumetric efficiency, we have:

v=(\dot{m}ₑᵣᵣ·60)/(estimated intake pressure·Ne)+\hat{v} (E)

Now, the intake pressure that truly corresponds to target load can be calculated:

P_{in,true}=target load/v=(estimated intake pressure·\hat{v})/v (F)

and finally,

P_{in,true}=est. intake pres.·\hat{v}/(((\dot{m}ₑᵣᵣ·60)/(est. intake pres.·Ne))+\hat{v}) (G)

In some embodiments, the P_{in,true} correction listed in equation G can be used to generate a target boost pressure to in turn provide a desired intake pressure as described in this disclosure.

FIG. 2 is a flow chart for an example engine control routine to achieve a target torque using air flow control in a torque based engine management system. In block 202, engine controller 12 determines if an engine is to undergo a boost pressure set point engine control routine according is the present embodiment. In block 204, once a desired torque is determined, a target boost is determined in block 206 and then the correct air flow is provided by adjusting engine parameters to achieve the target boost in block 208. In this way, an engine controller 12 can control an engine 10 to deliver a specified torque even in situations where modeled volumetric efficiency is less accurate due to high altitudes, transient states, heated piping, etc.

FIG. 3 illustrates an example method to determine target boost. In block 302, engine controller 12 determines if an engine is to undergo a boost pressure set point engine control routine according is the present embodiment. In block 304 a flow deviation signal is created by comparing estimated air flow to mass air flow. Then, in block 306, an intake pressure correction is calculated using the flow deviation signal and a modeled volumetric efficiency. Therefore boost pressure can be adjusted using the intake pressure correction to reach a set point for boost pressure control in block 308.

In the present example, an intake pressure required to meet a target load may be determined by modeling the volumetric efficiency of engine 10 and correcting for the difference between modeled and measured air flow from MAF sensor 120. For a low pressure drop over throttle 64, the modeled air flow is almost entirely dependant of volumetric efficiency, i.e. the throttle area has a negligible influence.

To calculate required boost pressure 44, a throttle pressure drop is added to the required intake pressure 46. The throttle pressure drop may have static and dynamic parts. For example, a static throttle pressure drop may be a function of engine speed as determined by PIP signal from Hall-effect sensor 118 and a required intake pressure 46 to meet a target load. The static throttle pressure drop should be close to or equal to zero at full load operation. A dynamic pressure drop may then be added during transients to compensate for errors in a feed forward part of the boost control, thus giving a closed loop control time to correct error before the extra pressure is removed.

In some embodiments, engine controller 12 calculates target boost pressure by calculating the required intake pressure 46, adding the required throttle pressure drop over throttle 64, and incorporating the upper and lower limitations of the calculated boost pressure. In this manner, the required intake pressure 46 is based on a target load equivalent intake pressure by subtracting an estimated pressure error based on the difference between the MAF sensor 120 and the modeled air flow.

The target load equivalent pressure may be calculated using the modeled volumetric efficiency of the engine. The modeled air flow may be calculated using a throttle model. It is therefore not obvious that the error in modeled air flow can be translated to an error in required intake pressure. However, as discussed above, at small pressure drops over the throttle, the throttle area itself is not very important for the modeled air flow.

Referring now to FIG. 4, if the difference between measured and modeled air flow is interpreted as an error in estimated volumetric efficiency the flow error can be used to correct the required intake pressure. FIG. 4 illustrates how load depends on intake pressure for both true filling and estimated volumetric efficiency. The area of interest is marked as a triangle with one of the corners defined by target load and estimated equivalent intake pressure. The horizontal cathetus is the step in pressure needed to find the intake pressure required to meet target load. The vertical cathetus correlates to the difference between measured and modeled air flow and the slope of the hypotenuse is the modeled volumetric efficiency, expressed as load per pressure [(g/rev)/kPa].

The pressure correction is then found according to equation (H):

$${p}_{corr} = {\dot{m}}_{err} \cdot \frac{60}{\hat{v} \cdot Ne} \qquad ( H )$$

In some embodiments, the modeled volumetric efficiency used in the function is simply the load over the intake pressure 46. In practice, the true filling line in FIG. 4 may be a bent line, not passing through the coordinate origin. This can cause a small error in the pressure correction and to compensate for that a sign dependant gain is added, according to equation (I):

$${p}_{corr} = {\dot{m}}_{err} \cdot \frac{60}{\hat{v} \cdot Ne} \cdot G ( sgn ( {\dot{m}}_{err} ) ) \qquad ( I )$$

At full load there should be minimal pressure drop over throttle 64. If the corrected required intake pressure is too low it may not be possible to meet a target load. The sign dependant gain may be used so the corrected intake pressure is never lower than the pressure actually required to meet target load. Since the flow error is taken as measured flow minus modeled flow the pressure correction should be reduced from the estimated pressure. The sign dependant gain therefore may be slightly less than unity for positive errors and slightly higher for negative errors.

Even though there is no explicit feedback involved in these calculations, the corrected intake pressure can have an effect on the flow through the engine and thus the flow error. In one approach to limit feedback caused instability, the pressure correction term can be low pass filtered before it is reduced from the estimated required intake pressure. In some embodiments, pressure can be added to compensate for errors in the boost feed forward control that can cause boost pressure to first stabilize around a pressure a few kPa above or below target boost. By lifting the target for about the same time as it takes for the feedback control to reach target, the boost pressure is high enough for the throttle 64 to meet a target load.

Note that the example control and estimation routines included herein can be used with various engine and/or hybrid propulsion system configurations. The specific routines described herein may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated steps or functions may be repeatedly performed depending on the particular strategy being used. Further, the described steps may graphically represent code to be programmed into computer readable storage medium in control system 12.

It will be appreciated that the configurations and routines disclosed herein are exemplary in nature, and that these specific embodiments are not to be considered in a limiting sense, because numerous variations are possible. For example, the above technology can be applied to V-6, I-4, I-5, I-6, V-12, opposed 4, and other engine types. Further, boost pressure may be adjusted based on engine maps as a function of engine parameters and may further include feedback adjustments based on sensor data. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating an internal combustion engine having a turbocharger, the method comprising:
comparing estimated air flow to a measured mass air flow to create a flow deviation;
determining an intake pressure correction using the flow deviation and a modeled volumetric efficiency; and
adjusting boost pressure using the intake pressure correction to reach a set point for boost pressure control.

2. The method of claim 1 wherein the estimated air flow is based on measured boost pressure, throttle angle and volumetric efficiency.

3. The method of claim 2 wherein the measured boost pressure is determined using a boost pressure sensor.

4. The method of claim 1 wherein the boost pressure set point is determined by calculating a required intake pressure, adding a required throttle pressure drop to the required intake pressure to generate a calculated boost pressure, a and only setting the boost pressure set point if the calculated boost pressure is within upper and lower limitations.

5. The method of claim 1 further comprising, providing a target torque by adjusting boost pressure.

6. The method of claim 1 wherein the estimated air flow is calculated without using a manifold absolute pressure sensor.

7. The method of claim 1 wherein a correct volumetric efficiency is not explicitly calculated.

8. A computer readable storage medium having stored data representing instructions executable by a computer for controlling an internal combustion engine having a turbocharger, the computer readable storage medium comprising instructions for:
comparing estimated air flow to a measured mass air flow to create a flow deviation;
calculating an intake pressure correction using the flow deviation and a modeled volumetric efficiency; and
adjusting boost pressure using the intake pressure correction to reach a set point for boost pressure control.

9. The computer readable storage medium of claim 8 further comprising instructions for estimating air flow based on measured boost pressure, throttle angle and volumetric efficiency.

10. The computer readable storage medium of claim 9 wherein the measured boost pressure is determined using a boost pressure sensor.

11. The computer readable storage medium of claim 8 further comprising instructions for determining a boost pressure set point by calculating a required intake pressure, adding a required throttle pressure drop to the required intake pressure to generate a calculated boost pressure, and only setting the boost pressure set point if the calculated boost pressure is within upper and lower limitations.

12. The computer readable storage medium of claim 8 further comprising instructions for providing a target torque by adjusting boost pressure.

13. The computer readable storage medium of claim 8 wherein the estimated air flow is calculated without using a manifold absolute pressure sensor.

14. An engine, comprising:
a turbocharger to increase air flow in a combustion chamber;
a pressure sensor between the turbocharger and the combustion chamber;
a mass air flow sensor to measure intake air into the combustion chamber; and
a controller coupled to the turbocharger, pressure sensor and mass air flow sensor, the controller to:
compare an estimated air flow to a measured mass air flow sensor reading to create a flow deviation signal;
calculate an intake pressure correction using the flow deviation signal and a modeled volumetric efficiency; and
adjust boost pressure using the intake pressure correction to reach a set point for boost pressure control.

15. The engine of claim 14 wherein the estimated air flow is based on measured boost pressure, throttle angle and volumetric efficiency.

16. The engine of claim 15 wherein the measured boost pressure is determined using a boost pressure sensor.

17. The engine of claim 14 wherein the boost pressure set point is determined by calculating a required intake pressure, adding a required throttle pressure drop to the required intake pressure to generate a calculated boost pressure, and only setting the boost pressure set point if the calculated boost pressure is within upper and lower limitations.

18. The engine of claim 14 wherein the controller can adjust boost pressure to provide a target torque.

19. The engine of claim 14 wherein the estimated air flow is calculated without using a manifold absolute pressure sensor.

20. The engine of claim 14 wherein a correct volumetric efficiency is not explicitly calculated.
